(19) United States
(12) Patent Application Publication
(10) Pub. No.: US 2017/0289429 A1
(43) Pub. Date: Oct. 5, 2017

(54) SYSTEMS AND METHODS FOR PRODUCING AN OUTPUT IMAGE

(71) Applicant: Mediatek Inc., Hsin-Chu City (TW)

(72) Inventors: Cheng-Che CHAN, Zhubei City (TW); Cheng-Che CHEN, New Taipei City (TW)

(21) Appl. No.: 15/088,079

(22) Filed: Mar. 31, 2016

(51) Int. Cl. H04N 5/232; H04N 5/235

(52) U.S. Cl. CPC H04N 5/23209; H04N 5/2355; H04N 5/2356; H04N 5/23241

(57) ABSTRACT

The embodiments of the present invention relate to systems and methods for producing an output image. The systems and methods can produce an output image by detecting motion in a scene and taking a corresponding action based on whether motion is detected in the scene. If motion is detected, the systems and methods employ images captured by two or more image sensors to produce an output image. If motion is undetected, the systems and methods employ images captured by one image sensor to produce an output image.

### FIELD OF THE INVENTION

The present invention relates to systems and methods for producing an output image, and particularly related to producing an output image involving motion or multiple operational controls.

### BACKGROUND OF THE INVENTION

Most existing image sensors may miss details of real world scenes since real world scenes contain an extremely wide range of focal depths, radiance, and color, while dynamic ranges (DR) of the images sensors are relatively narrow compared to human eyes. For example, when taking a picture “against the light,” meaning, capturing a high contrast scene in which a very bright area with high illumination coexists with a very dark area with low illumination, the details in the very bright area or very dark area may disappear in the obtained picture. In other words, when taking a picture in a high contrast environment, original colors, tones, and details appearing in an actual scene may disappear in a high illumination area or a low illumination area.

Most cameras incorporating image sensors have adjustable optical settings, such as the focus, exposure, and aperture. In such systems, the camera includes some form of automatic adjustment of these settings, such as auto-focus (AF), automatic gain (AG), and auto-exposure (AE).

To overcome the aforementioned problem, one common resolution is that the camera may capture several frames of the same scene under different settings and combine the captured images to create an image in which an improved level of detail appear. However, if the scene is not static during the sequence acquisition, e.g., due to moving objects in the scene or motion of the camera, objects in the scene may manifest themselves as ghosting artifacts in the created image.

Accordingly, there is a need for improved systems and methods for creating an image free from or with reduced ghosting effect. There are also other deficiencies that can be remedied based on illustrative descriptions provided herein.

### SUMMARY OF THE INVENTION

In accordance with one embodiment of the present invention, a device for producing an output image using one or more image sensors is contemplated. The device may comprise a plurality of image sensors that each outputs a captured image if that image sensor is activated to capture a scene, and each image sensor has a different perspective view of the scene; and a processor that is configured to receive an input signal instructing the device to produce an output image, perform sensor activation wherein, in response to receiving the input signal, the processor controls whether each image sensor is activated, implement motion processing that determines whether there is motion in the scene and generates a motion output based on the determination, and select output from which image sensor to use as a function of the motion output and sensor activation in producing the output image in accordance with at least two captured images.

In some embodiments, the processor may be further configured to selectively apply power to one or more individual ones of the image sensors whereby the processor powers on or power off a corresponding image sensor.

In some embodiments, the processor may be further configured to selectively apply power to one of the image sensors while the processor maintains a second one or all other ones of the image sensors to be power off.

In some embodiments, the processor may be further configured to apply power to one or more individual ones of the image sensors before or approximately at the same time as the processor activates a corresponding image sensor to capture an image.

In some embodiments, the processor may be further configured to perform activation to capture a scene only after the processor selectively applies power to one or more individual ones of the image sensors to power that correspond sensor on to be operable.

In some embodiments, the processor may be further configured to implement a power saving mode for the device in which the processor is configured to remove power from being applied to a particular one of the image sensors in order to turn that image sensor off while the device continues to operate.

In some embodiments, the processor may be further configured to activate only one of the image sensors to capture a scene in response to receiving the input signal.

In some embodiments, the processor may be configured to activate at least two of the image sensors to operate simultaneously with respect to capturing a scene.

In some embodiments, the processor may be configured to select output from only one of the image sensors to be the at least two captured images when the processor has powered off one or more other sensors.

In some embodiments, the processor is configured to power off the one or more other sensors as part of implementing a power savings mode for the device.

In some embodiments, the processor may be configured to select output from only one of the image sensors to be the at least two captured images when the motion output indicates that motion has not been detected in the scene.

In some embodiments, the processor may be configured to select output from a first one of the image sensors and a second one of the image sensors to be the at least two captured images.

In some embodiments, the processor may be configured to select output from the second one of the image sensors to be included in the at least two captured image when the processor determines from the motion output that motion has been detected in the scene.

In some embodiments, the processor may be configured to produce the output image in accordance with the at least two captured images.

In some embodiments, the processor may be configured to produce the output image in accordance with the at least two captured images, wherein the at least two captured images are only from one of the image sensors.

In some embodiments, the processor may configured to produce the output image in accordance with the at least two captured images, wherein the at least two captured images are plural captured images from one of the image sensors and plural captured images from another one of the image sensors.

In some embodiments, the processor may be configured to determine whether there is motion in the scene by processing captured images from one of the image sensors and other one of the image sensors.

In some embodiments, the processor may be configured to determine whether there is motion in the scene by processing captured images from only one of the image sensors.

In some embodiments, the processor is configured to display the output image on a display screen of the device in response to receiving the input signal.

In some embodiments, the processor may be configured to select output from which sensor comprising the processor being configured to receive captured images which are output by the image sensors.

In accordance with another embodiment of the present invention, a computer-implemented method for producing an output image is contemplated. The method may comprise receiving an input signal instructing a device comprising a plurality of image sensors and a processor to produce an output image, wherein each image sensor outputs a captured image if that image sensor is activated to capture a scene, and each image sensor has a different perspective view of the scene; performing sensor activation, wherein, in response to receiving the input signal, allowing the processor to control whether each image sensor is activated; implementing motion processing that determines whether there is motion in the scene and generates a motion output based on the determination; and selecting output from which image sensor to use, by the processor, as a function of the motion output and sensor activation in producing the output image in accordance with at least two captured images.

In accordance with yet another embodiment of the present invention, a non-transitory computer readable storage medium configured to store computer instructions that when executed causes a processor to produce an output image is contemplated. The medium may comprise receiving an input signal instructing a device comprising a plurality of image sensors and the processor to produce an output image, wherein each image sensor outputs a captured image if that image sensor is activated to capture a scene, and each image sensor has a different perspective view of the scene; perform sensor activation, wherein, in response to receiving the input signal, the processor controls whether each image sensor is activated; implement motion processing that determines whether there is motion in the scene and generates a motion output based on the determination; and select output from which image sensor to use as a function of the motion output and sensor activation in producing the output image in accordance with at least two captured images.

### BRIEF DESCRIPTION OF THE DRAWINGS

The nature and various advantages of the present invention will become more apparent upon consideration of the following detailed description, taken in conjunction with the accompanying drawings, in which like reference characters refer to like parts throughout, and in which:

FIG. 1 depicts an illustrative method for producing an output image in accordance with some embodiments of the present invention;

FIG. 2 depicts an illustrative arrangement for application of power to the image sensors in accordance with some embodiments of the present invention;

FIG. 3 is a diagram illustrating captured images output by at least two image sensors in accordance with some embodiments of the present invention;

FIG. 4 depicts an illustrative flow chart for producing images in accordance with some embodiments of the present invention;

FIG. 5 depicts an illustrative flow chart for producing images using one image sensor in accordance with some embodiments of the present invention; and

FIG. 6 depicts an illustrative device such as a smartphone or tablet or producing an output image in accordance with some embodiments of the present invention.

### DETAILED DESCRIPTION OF THE INVENTION

Embodiments of the present invention relate to systems and methods for producing an output image. The systems and methods can produce an output image by detecting motion in a scene and taking a corresponding action based on whether motion is detected in the scene. If motion is detected, the systems and methods employ images captured by two or more image sensors to produce an output image. If motion is undetected, the systems and methods employ images captured by one image sensor to produce an output image. Through various innovative techniques, the operation of a single or multiple sensors, and power applied to the sensors is managed to provide enhanced images and superior device performance.

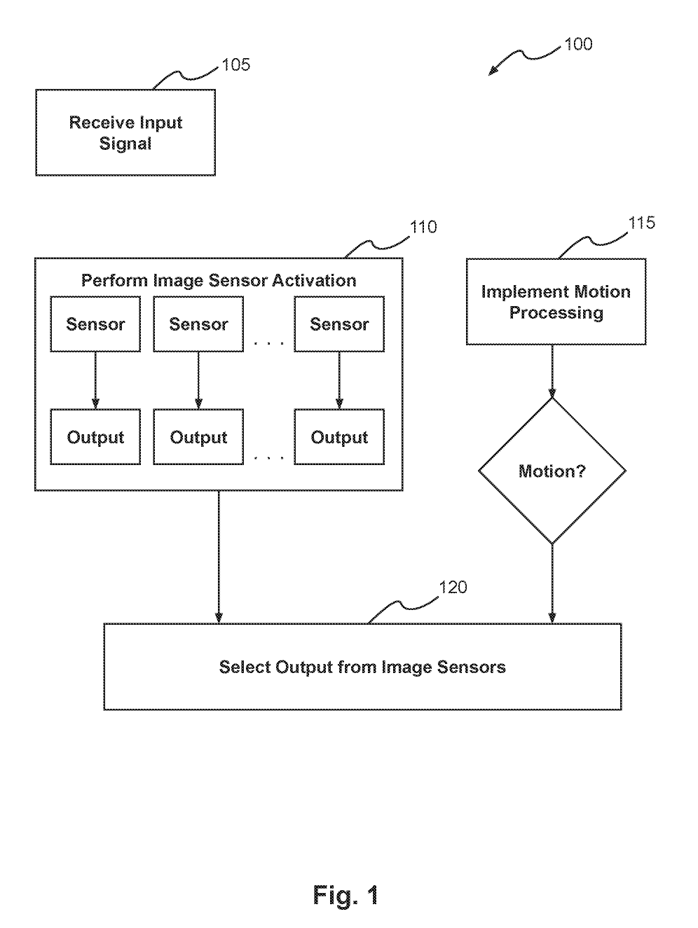

Referring to FIG. 1, one embodiment of the method 100 for producing an output image is illustrated. The method 100 may commence with receiving an input signal instructing a device to produce an output image (step 105). The device may be a mobile device or a stationary device. A mobile device may be a device that is designed to be used or operated while being held in the hand such as a cellular phone, a tablet, a personal data assistant (PDA), or the like. A mobile device may also be a laptop computer. A stationary device may be a device that is designed for regular use at a single location due to its size and power requirements. The device, whether it is a mobile device or a stationary device, may communicate wirelessly over a network. The device may comprise a plurality of image sensors and a processor and is preferably a mobile device or a smartphone. The input signal may be an electrical signal, a mechanical signal, an acoustic signal, infrared signal, any other form of signal, or any combination thereof. The input signal may be generated by pressing a mechanical button of the device or a remote control of the device, pressing the display of the device if the display is a touch-screen panel, speaking to the device, or other manner accepted by the device. The input signal may be a signal that causes the performance of image sensor activation (step 110), motion processing (step 115), and/or image sensor output selection (step 120) each of which is described below. The output image may be an image produced after performing one or more all) of the steps 110, 115, 120, and the input signal may be a signal that causes the device to produce such an image.

In response to receiving the input signal, the method 100 may perform image sensor activation (step 110). The device may comprise a plurality of image sensors, and step 110 may activate one or more of the plurality of image sensors and control whether each image sensor is activated to capture a scene. In other words, step 110 may activate any particular one of the image sensors and any number of the image sensors to capture a scene. In one embodiment, step 110 may activate only one of the image sensors to capture a scene in response to receiving the input signal. In another embodiment, step 110 may also activate at least two of the image sensors to capture a scene in response to receiving the input signal. The “only one” sensor and the “at least two” image sensors may be any one of the image sensors or a certain sensor(s) from among the image sensors. When at least two of the image sensors are activated, step 110 may activate the image sensors to operate simultaneously (at the same time or approximately at the same time) with respect to capturing a scene.

Each of the plurality of image sensors may output the captured scene as a captured image once the image sensor is activated. It should be understood that other types of sensors can be used in the process. Each of the plurality of image sensors may capture a scene multiple times upon activation and output a captured image each time. The image sensors may be controlled by an application or operating system running the device. The image sensors can be integrated on a single device such as a mobile handset or smartphone and can be facing in the same direction but positioned to be distanced apart to capture an image of the same view at different angles. The device may also have a processor, and the processor may temporarily save the captured images. The processor may store the captured images in a buffer or volatile memory of the device. An image sensor that is capable of being activated may be a powered-on image sensor or an image sensor that is in operation. Such an image sensor is operable to capture an image when activated. Image sensors and sensors used in image capture are generally known to those of ordinary skill in the art in this field of technology.

The method 100 may implement motion processing that determines whether there is motion in the scene and generates an output based on the determination (step 115). It should be understood that this can include performing motion detection and sensor activation (or operation) in parallel or in other variations. Motion processing may determine whether there is motion in the scene from captured images, and the captured images may be from only one of the image sensors or from at least two of the image sensors. Other received or captured information can be used. When the captured images are from only one of the image sensors, the captured images may be obtained by the image sensor by capturing the scene multiple times upon each activation resulting in an output comprising a captured image each time. When the captured images are from two or more of the image sensors, the captured images can be obtained by each of the two or more image sensors capturing the scene once upon each activation and outputting a captured image. The captured images may also be obtained by each of the two or more image sensors capturing the scene more than once. Each output is a captured image for each time. In any of the above scenarios, motion processing may determine whether there is motion in the scene by analyzing movement in one or more dimensions of the captured images. For example, motion processing may analyze movement in X and Y axes or X, Y, and Z axes of the captured images.

In some embodiments, additional one or more other type(s) of sensors, such as one or more motion sensors, in addition to the image sensors or their images, can also be implemented to sense and detect motion. In other embodiments, one or more other types of sensors, for example, a motion sensor, instead of the image sensors or their images, can be implemented to sense and detect motion. The motion being, sensed, detected, or determined may be local motion, global motion, or both local motion and global motion. Local motion refers to motion caused by a moving object while global motion refers to motion caused by motion of the image sensor(s) or the device.

Based on the above processes, the method 100 may select output from which image sensor to use as a function of the motion output and image sensor activation in producing the output image (step 120). Depending on which and how many image sensors are activated during image sensor activation and whether there is motion in the scene in motion processing, the method 100 may select output from which activated image sensor to be used in producing the output image. Output of the image sensor refers to the captured images of the image sensor. Image sensor activation refers to a powered-on sensor receiving a trigger signal and in response, the sensor captures an image of the current view of the sensor. The method 100 may produce the output image from the selected output, and the output image may be produced in accordance with at least two captured images. The method 100 may produce the output image without requiring resources external to the device. Depending on the situation, the at least two captured images may be from the same image sensor or different image sensors. The method 100 may comprise utilizing software or hardware on the device that produces the output image. The method 100 may display the output image on a display screen of the device in response to receiving the input signal. The method 100 may save the output image in non-volatile memory of the device for later retrieval by a user of the device.

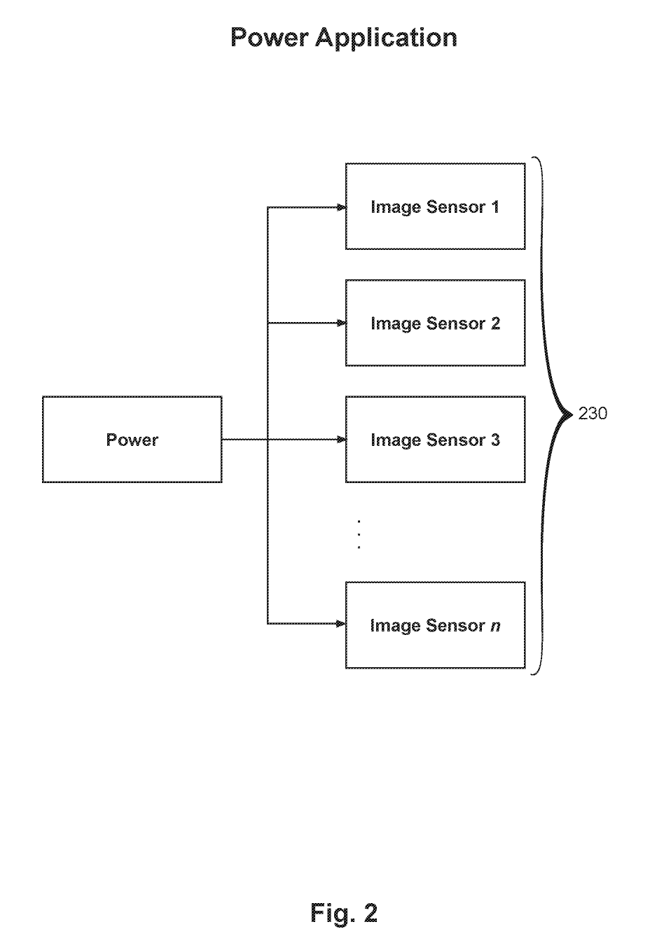

The discussion now will turn to powering “on” (selectively switching power to be applied to the image sensor at a level that puts the image sensor in its normal operating state) an image sensor which makes it capable of being activated in the activation step 110. An image sensor may be powered on by applying power to the image sensor. FIG. 2 is illustrative of such a power application process. The application process may be a part of the method 100.

The method may selectively apply power to one or more of the image sensors to power on the one or more image sensors. For example, referring to FIG. 2, the method may select image sensor 1 and image sensor 3 from the image sensors 230 and apply power to those image sensors. The applied power may power on images sensors 1 and 3 so they can be activated to capture a scene. In other words, image sensors 1 and 3 can be activated to capture a scene only after power is applied to those image sensors. Before power is applied, the image sensors may be power off.

The applied power may be the power relied on by image sensors 1 and 3 to operate without capturing a scene (or to be ready for capturing a scene without capturing a scene). The applied power may also be the power to turn on the image sensor from an off state in which the image sensor consumes no or negligible amount of power to an on state in which the image sensor consumes power for supporting its operational features. For example, before activation and while power is on, image sensors 1 and 3 may view the scene without capturing the scene.

The method may apply power to the one or more of the image sensors before or approximately at the same time as the activation step 110. The method may maintain a second one or the remaining image sensors to be powered off. A powered-off image sensor may refer to an image sensor that is not in operation or an image sensor in an off state. Applying power to image sensors in turn controls which image sensors can be activated.

In some embodiments, the method may selectively control the application of power to one or more of the image sensors to power off the one or more image sensors. The one or more image sensors may be some of the image sensors that are already power on, and the method may reduce the number of image sensors that may be activated by powering off the one or more image sensors. Stated differently, the method may remove power from being applied to a particular one of the image sensors in order to turn that image sensor off while the device continues to operate. For example, referring to FIG. 2, image sensor 1, image sensor 2, and image sensor 3 may already be powered on, and the method may select image sensor 1 and image sensor 3 and apply power to those image sensors. The applied power may power off image sensors 1 and 3 so they cannot be activated to capture a scene but the remaining image sensor 2 and the device may continue to operate. Such power removal process may be implemented as a power saving mode for the device.

The discussion now will be directed to the manners in which the method 100 may select output from which image sensor to use as a function of the motion output and the image sensor activation. As mentioned above, the image sensor activation may activate only one or at least two or more of the image sensors to capture a scene in response to receiving the input signal.

When at least two of the image sensors are activated, a plurality of captured images may be output by the at least two of the image sensors. Each of the at least two of the image sensors may be activated to capture a scene and output the captured scene as a captured image. When each of the at least two of the image sensors is activated to capture a scene once, the plurality of captured images may comprise a captured image from each of the at least two image sensors. Each of the at least two image sensors may also capture the scene multiple times upon activation and output a captured image for each time. In this situation, the plurality of captured images may comprise multiple captured images from each of the at least two image sensors. In either situation, each of the least two image sensors may capture the scene simultaneously each time (e.g., approximately at the same time).

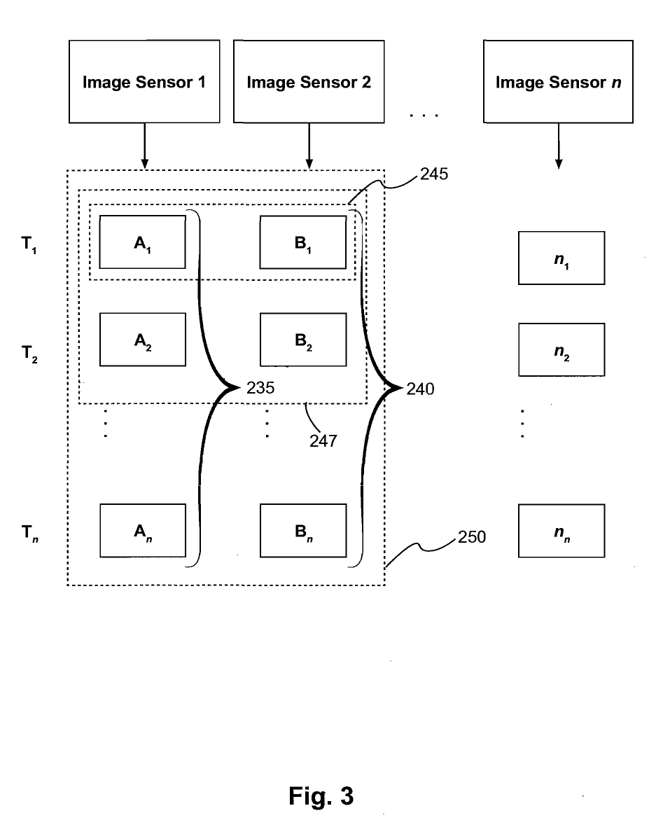

FIG. 3 depicts illustrative captured images output by at least two of the image sensors. The device may have N number of image sensors, and the at least two of the image sensors may comprise image sensor 1 and image sensor 2. Image sensor 1 may capture one or more first images 235 in succession or at one or more first captured times and image sensor 2 may capture one or more second images 240 in succession or at one or more second captured times. Image sensor 1 may capture a first image A₁ at a first captured time T₁, another first image A₂ at another first captured time T₂, and so on. Image senor 2 may capture a second image B₁ at a second captured time T₁, another second image B₂ at another second captured time T₂, and so on. When each of image sensor 1 and image sensor 2 only captures one image, e.g., first image A₁ and second image B₁, respectively, the plurality of captured images may comprise A₁ and B₁ or images 245. When each of image sensor 1 and image sensor 2 captures two or more first images and two or more second images, respectively, the plurality of captured images may comprise images 247 or images 250 depending on how many first images and second images are captured. Image sensor 1 and image sensor 2 may be configured such that each of the one or more second images 240 is captured at the same time as each of the one or more first images 235 or vice versa. Each of the one or more first images 235 can be captured by image sensor 1 at a first angle and each of the one or more second images 240 can be captured by image sensor 2 at a second angle different from the first angle. As such, except for the difference in angle, the scene in image A₁ and the scene in image B₁ are the same, the scene in image A₂ and the scene in image B₂ are the same, and so forth. If there is motion in image A₁ or other image A, the same motion also exists in image B₁ or the corresponding image B. As mentioned, the only difference between each image A and each image B is that the capturing angle or perspective is different. The at least two of the image sensors may comprise additional image sensors or any number of image sensors between two and N, and the above principles also apply to those image sensors.

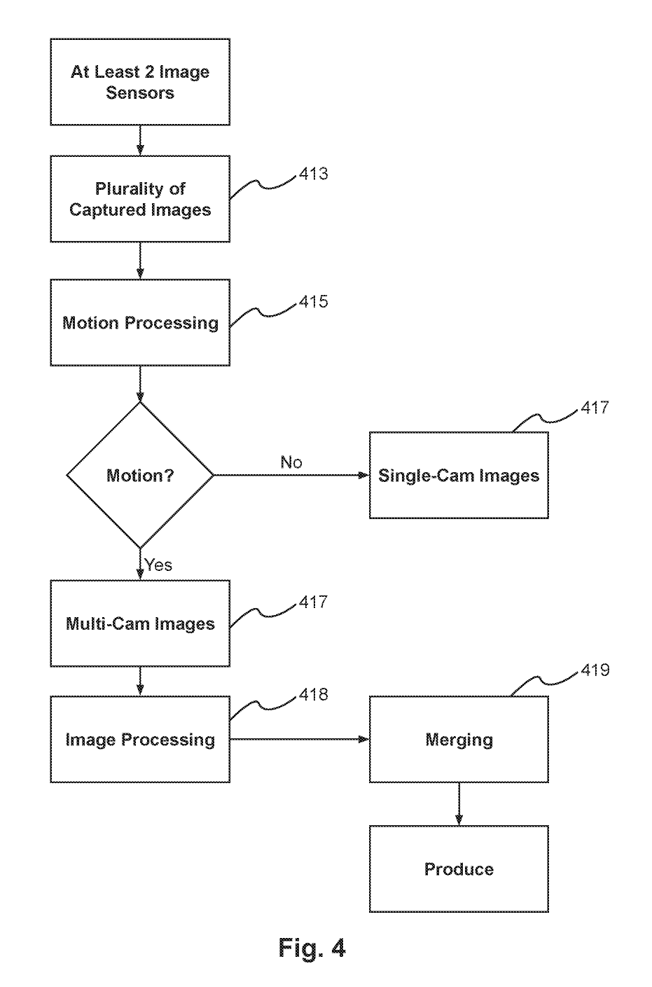

After the at least two image sensors are activated and output a plurality of captured images, motion processing 415 and output selection 417 may follow as shown in FIG. 4. Motion processing 415 may determine whether there is motion in the scene from the plurality of captured images 413. The plurality of captured images 413 may be those described with respect to FIG. 3. Motion is preferably determined from at least two of the captured images of the plurality 413. In one way, motion may be determined from at least two captured images from one of the at least two image sensors. For example, referring to FIG. 3, motion may be determined from at least images A₁, A₂, at least images B₁, B₂, or other consecutive images from the same image sensor. In another way, motion may be determined from at least two captured images with a captured image from one of the at least two image sensors and a captured image from other one of the at least two image sensors. For example, referring to FIG. 3, motion may be determined from at least images A ₁ and B₁ or additional images from additional image sensors captured at the same time (or approximately at the same time). In a third way, motion may be determined from at least two captured images from each of the at least two image sensors. For example, referring to FIG. 3, a first motion information may be determined from at least images A₁, A₂, and a second motion information may be determined from at least images B ₁, B₂, and so forth for each image sensor. Motion may then be determined based on the first motion information, the second motion information, and/or the motion information from each of the remaining activated sensors. The third manner of motion determination (discussed herein) may obtain a better motion vector from the scene such as, better movement or deformation information of the moving objects if there are any in the scene. The last manner of motion determination may bring in additional motion information that may be utilized in image processing or image rectification (described below) to produce a better quality output image. Motion processing may generate a motion output based on the determination.

When the motion output of motion processing indicates that there is no motion in the scene, the method may select at least two captured images from one of the at least two image sensors (or single-cam images) in producing the output image. For example, referring to FIG. 3, single-cam images may be one or more images from the first images 235, one or more images from the second images 240, or one or more images output by another image sensor. When the motion output indicates that there is motion in the scene, the method may select at least one of the captured images from one of the at least two image sensors and at least one of the captured images from other one of the at least two image sensors (or multi-cam images) in producing the output image. The selected images are images captured at the same time. For example, referring to FIG. 3, multi-cam images may have at least one image from the first images 235 such as A₁ and at least one image from the second images 240 such as B₁.

Activating at least two image sensors can refer to activating a plurality of image sensors (but potentially less than the total number of image sensors the device has), the remaining image sensors may be either powered off or powered on but not activated.

Subsequent to output selection, the method may perform image processing 418 on the selected output and/or merge 419 the selected output. Image processing, for example, may be or comprise image rectification. Image rectification may refer to aligning images captured at two different angles or to correct issues associated with images having two different viewing angles. When at least two image sensors are activated and there is no motion in the scene, the selected output may be at least two consecutive captured images from the same image sensor (single-cam images) in any of the at least two image sensors. In this situation, the least two consecutive captured images may be merged and the merged image may be produced as an output image. Image rectification is not performed on the single-cam images. When at least two image sensors are activated and there is motion in the scene, the selected output may be at least two captured images with one image from one of the at least two image sensors and with one image from other one of the at least two image sensors (multi-cam images). The selected images are images captured at the same time. In this situation, the at least two captured images may undergo image processing and the processed images may be merged afterward. The merged image may then be produced as an output image.

When at least two image sensors are activated, the method produces an output image faster when motion is detected since all the images for producing an output image when motion is detected are already captured or available to the device.

In some embodiments, power savings can be obtained by selectively powering “on” additional sensors only when motion is detected in connection with the user taking a picture. When only one of the image sensors is activated, one or more captured images may be output by the one image sensor. The image sensor may be activated to capture a scene and output the captured scene as a captured image. The image sensor may also capture the scene multiple times upon activation and output a captured image for each time. The image sensor may be any sensor of the device. For example, referring to FIG. 3, the image sensor may be image sensor 1 and it may capture one or more first images 235 as described. Detecting motion can cause the device to power on and activate one or more additional sensors.

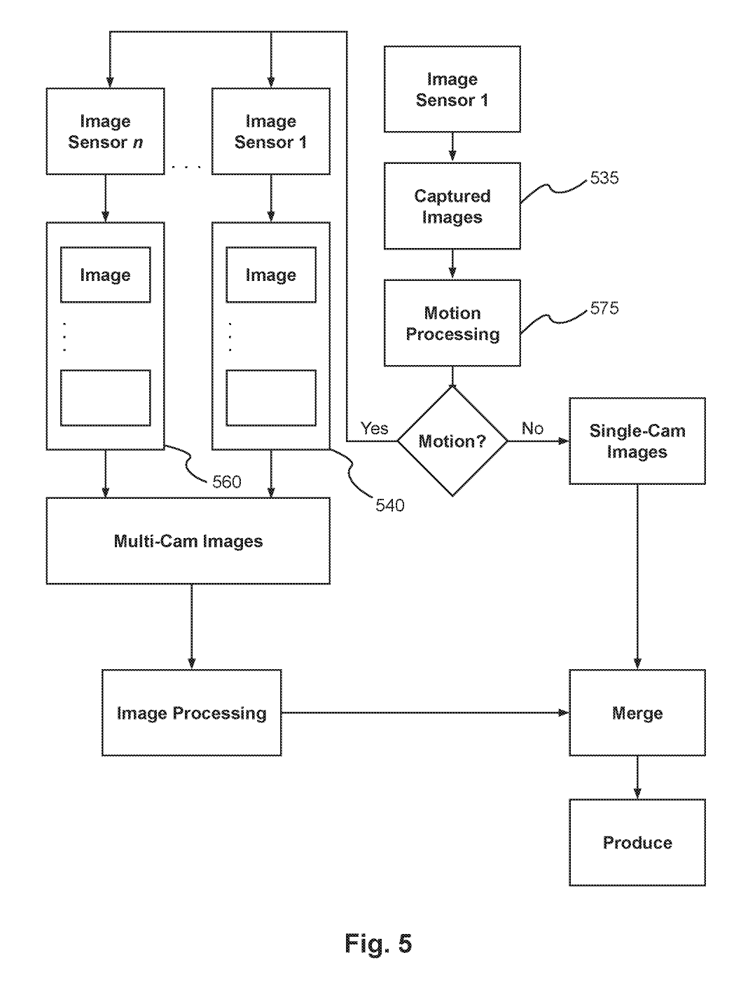

After the image sensor is activated (a user selects to take a picture), motion processing, image sensor activation, and output selection may follow as shown in FIG. 5. The image sensor preferably output more than one captured image, and motion processing may determine whether there is motion in the scene from at least two of the captured images. For example, referring to FIG. 3, motion may be determined from at least images A₁, A₂ of the first images 235 when the one image sensor is image sensor 1. Captured images 535 in FIG. 5 may correspond to the first images 235. Motion processing may generate a motion output based on the determination.

When the motion output indicates that there is no motion in the scene, the method may select at least two of the image sensor's captured images 535 in producing the output image. Captured images 535 may be referred to as single-cam images. When the motion output indicates that there is motion in the scene, image sensor activation may be executed again to activate a second or more image sensors. The activated second or more image sensors may capture the same scene and each may output one or more captured images. Each of the second or more image sensors may output one or more captured images 540, 560. The method may select at least one of the captured images 535 from the image sensor and at least one of the captured images from the second image sensor (if only one image sensor is powered on and activated in response) or from each of the subsequent activated image sensors (if more than one image sensor is powered on and activated in response). In these embodiments, some sensors are powered off to provide battery or power savings and are powered on and activated to capture an image when an event, motion in the current view is detected. For example, when there are N subsequent active image sensors, the method may select an image from captured images 540, an image from captured images of another image sensor, and so forth to an image from captured images 560 of image sensor N in addition to selecting at least one of the captured images 535 from the image sensor. The images selected from different image sensors may be referred to as multi-cam images. Before motion processing determines that there is motion in the scene, the second or more image sensors may be powered off. Activating only one image sensor (or powering on only one image sensor to be ready for activation) while maintaining the second or more image sensors to be power off may be part of implementing a power savings mode for the device.

The second or more image sensors may be powered off before activation, and then be powered on and activated to capture images only when motion is detected. In some embodiments, the second or more image sensors may be already powered on, and be activated to capture images when motion is detected.

Subsequent to output selection, the method may perform image processing on the selected output and/or merge the selected output. Image processing, for example, may be or comprise image rectification. When only one image sensor is activated and there is no motion in the scene, the selected output may be at least two consecutive captured images from the image sensor because other image sensors are not activated to output images. In this situation, the least two consecutive captured images may be merged and the merged image may be produced as an output image. Image rectification is not performed on the single-cam images. When a second or more image sensors are subsequently activated because there is motion in the scene, the selected output may be at least two captured images with one image from the image sensor and with one image from the second image sensor or from each of the subsequent activated image sensors. In this situation, the at least two captured images may undergo image processing and the processed at least two captured images may be merged afterward. The merged image may then be produced as an output image.

Based on the above descriptions, various embodiments can be implemented. For example, in one embodiment, a method involving a plurality of image sensors and a motion sensor may be implemented. The motion sensor may sense one or more frames and detect whether there is motion based the one or more frames. Before and when the sensing and detection are performed, all or at least one of the plurality of image sensors can be deactivated (e.g., power on but not activated or power off) or at least partially powered-down (e.g., in a state that consumes power less than power on state). When there is motion detected, at least two or all of the image sensors can be activated or powered on and then activated to capture images. When there is no motion detected, only one of the image sensors can be activated or powered on and then activated to capture images.

In another embodiment, a method involving a plurality of image sensors may be implemented. One of the image sensors may sense a plurality frames/images at different times and some of the frames/images may be used to determine whether there is motion. Before and when the sensing and detection are performed, the one of the image sensors that senses the frames/images can be activated and the other image sensors can be deactivated (e.g., power on but not activated or power off) or at least partially powered-down (e.g., in a state that consumes power less than power on state). When there is motion detected, one or more of the other images sensors can be activated or powered on and then activated, meaning that at least two or all of the image sensors can be activated or powered on and then activated to capture images. When there is no motion detected, only the one of the image sensors can be kept activated.

In further another embodiment, a method involving a plurality of image sensors may be implemented. At least two or all of the image sensor may sense a plurality frames/images at the same time or at different times, and some of the frames/images may be used to determine whether there is motion. Before and when the sensing and detection are performed, the image sensors that sense the frames/images can be activated. The remaining image sensors, if there are any, can be deactivated (e.g., power on but not activated or power off) or at least partially powered-down (e.g., in a state that consumes power less than power on state). When there is motion detected, the at least two or all of the image sensors can be activated to capture images. In other words, in an implementation where all of the images sensors are originally activated, they can be kept activated. In another implementation where some of the images sensors are originally activated, they can be kept activated, and additionally, one or more other images sensors can be activated. The activation of the one or more other images sensors is triggered when motion is detected. This means that at least two or all of the image sensors can be activated to capture images. When there is no motion detected, only one of the image sensors can be kept activated. This means that at least one of the originally-activated image sensors can be deactivated (e.g., change from activation state to power on state that does not capture images or to power off state). Originally-activated image sensors may refer to image sensors activated before the sensing and detection are performed, when the sensing and detection are performed, or before and when the sensing and detection are performed.

More other different embodiments can be implemented. Different numbers or types of sensors can be activated for motion detection. On the other hand, the number of image sensors to be activated for capturing more images can be determined based on the result of motion detection.

The steps described in FIGS. 1-5 may be implemented in multiple modules. For example, image sensor activation may be implemented by an image sensor activation module that is configured to receive the input signal and perform the processes described with respect to image sensor activation. Motion processing and output selection may be implemented by one single motion processing module that is configured to perform the processes described with respect to motion processing and output selection or by two separate modules with one for motion processing and one for output selection. Image processing may be implemented by an image processing module that is configured to perform the processes described with respect to image processing. Merging may be implemented by an image merging module that is configured to perform the processes described with respect to merging. Other steps may be similarly implemented by their corresponding modules. Some or all the modules may communicate with each other to perform their functions. In some embodiments, all the steps described in FIGS. 1-5 may be implemented in one single module. Module refers to a software module that is executed by the processor. In some embodiments, one or more modules can be hardware modules such as a specialized circuit or an integrated circuit that, for example, performs motion detection or merges images.

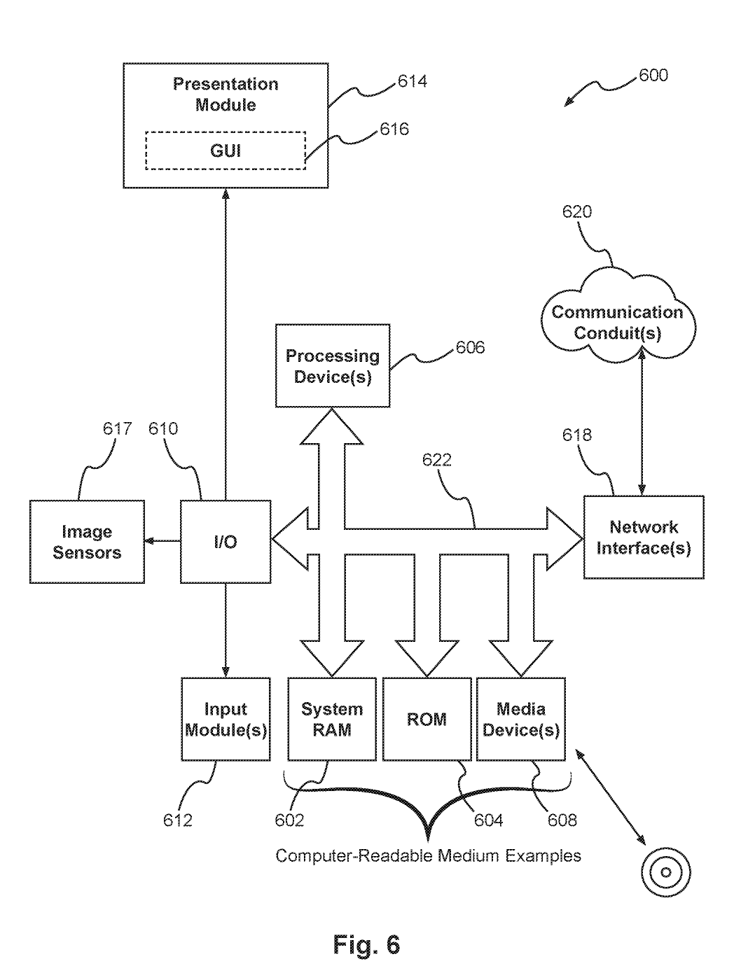

FIG. 6 depicts an illustrative device 600 for producing an output image. Device 600 is preferably a smartphone or tablet. Device 600 can be used to implement any aspect of the functions described above. FIG. 6 is not intended to limit the present disclosure, and that other alternative hardware environment may be used without departing form the scope of this disclosure. Methods or process illustratively described herein can be implemented on device 600.

The device 600 may include volatile memory (such as RAM 602) and/or non-volatile memory (such as ROM 604 as well as any supplemental levels of memory, including but not limited to cache memories, programmable or flash memories and read-only memories). The device 600 can also include as one or more processing devices 606 (e.g., one or more central processing units (CPUs), one or more graphics processing units (GPUs), one or more microprocessors (μP) and similar and complementary devices) and optional media devices 608 (e.g., a hard disk module, an optical disk module, etc.). The processor described above may be one or more of such processing devices.

The device 600 can perform various operations identified above with the processing device(s) 606 executing instructions that are maintained by memory (e.g., RAM 602, ROM 604 or elsewhere). The disclosed steps, modules, and other processes may also be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, or the like, the machine becomes an apparatus for practicing the presently disclosed steps, modules, and processes. When implemented on a general-purpose processor, the program code combines with the processor to provide a unique apparatus that operates to invoke the functionality of the presently disclosed steps, modules, and processes. Additionally,any storage techniques used in connection with the presently disclosed method and/or system may invariably be a combination of hardware and software.

The device 600 also includes an input/output module 610 for receiving various inputs from a user (via input modules 612), for receiving output from image sensors 617, and for providing various outputs to the user. The image sensors 617 may be those described above and may perform similar functions. The image sensors 617 may be charge-coupled devices (CCDs), active pixel sensors, complementary metal oxide semiconductor (CMOS) sensors, solid-state images sensors, or other similar sensors. One particular output mechanism may include a presentation module 614 and an associated graphical user interface (GUI) 616 incorporating one or more I/O devices (including but not limited to a display, a keyboard/keypad, a mouse and/or other pointing device, a trackball, a joystick, a haptic feedback device, a motion feedback device, a voice recognition device, a microphone, a speaker, a touch screen, a touchpad, a webcam, 2-D and 3-D cameras, and similar and complementary devices that enable operative response to user commands that are received at the device 600).

The device 600 can also include one or more network interfaces 618 for exchanging data with other devices via one or more communication conduits 620. One or more communication buses 622 communicatively couple the above-described components together. Bus 622 may represent one or more bus structures and types, including but not limited to a memory bus or memory controller, a peripheral bus, a serial bus, an accelerated graphics port, a processor or local bus using any of a variety of bus architectures and similar and complementary devices. This configuration may be desirable where the device 600 is implemented as a server or other form of multi-user computer, although such device 600 may also be implemented as a mobile device, a standalone workstation, desktop, or other single-user computer in some embodiments. In such configuration, the device 600 desirably includes a network interface in operative communication with at least one network. The network may be a LAN, a WAN, a SAN, a wireless network, a cellular network, radio links, optical links and/or the Internet, although the network is not limited to these network selections. It will be apparent to those skilled in the art that storage devices utilized to provide computer-readable and computer-executable instructions and data can be distributed over a network. The device 600 can operate under the control of an operating system that executes or otherwise relies upon various computer software applications. For example, a database management system (DBMS) may be resident in the memory to access one or more databases (not shown). The databases may be stored in a separate structure, such as a database server, connected, either directly or through a communication link, with the remainder of the device 600. Moreover, various applications may also execute on one or more processors in another computer coupled to the device 600 via a network in a distributed or client-server computing environment.

In some embodiments, motion processing and detection may be executed on the processor. In some other embodiments, motion processing and detection may be implemented on a component separated from the processor. Such a component may be a motion sensor that processes and determines whether there is motion and that generates an output signal based on the determination that is received by the processor. For example, the captured plurality of images or other information sensed by the device may be fed to the motion sensor (e.g., before providing to the processor). Based on the detection result, the process involving the motion sensor may select the appropriate images and provide the selected appropriate images to the processor. The processor may then either merge the received images or rectify the received images and merge the rectified images. In some other embodiments, motion processing may be implemented by the processor.

Counterpart computer-readable medium and other embodiments would be understood from the above and the overall disclosure. Also, broader, narrower, or different combinations of the described features are contemplated, such that, for example features can be removed or added in a broadening or narrowing way.

Software for implementing desired functionality is stored in non-volatile memory and applied to a processor to provide the functionality.

It is understood from the above description that the functionality and features of the systems, devices, or methods of embodiments of the present invention include generating and sending signals to accomplish the actions.

It should be understood that variations, clarifications, or modifications are contemplated. Applications of the technology to other fields are also contemplated.

Exemplary systems, devices, and methods are described for illustrative purposes. Further, since numerous modifications and changes will readily be apparent to those having ordinary skill in the art, it is not desired to limit the invention to the exact constructions as demonstrated in this disclosure. Accordingly, all suitable modifications and equivalents may be resorted to falling within the scope of the invention.

Thus, for example, any sequence(s) and/or temporal order of steps of various processes or methods (or sequence of device connections or operation) that are described herein are illustrative and should not be interpreted as being restrictive. Accordingly, it should be understood that although steps of various processes or methods or connections or sequence of operations may be shown and described as being in a sequence or temporal order, but they are not necessarily limited to being carried out in any particular sequence or order. For example, the steps in such processes or methods generally may be carried out in various different sequences and orders, while still falling within the scope of the present invention. Moreover, in some discussions, it would be evident to those of ordinary skill in the art that a subsequent action, process, or feature is in response to an earlier action, process, or feature.

It is also implicit and understood that the applications or systems illustratively described herein provide computer-implemented functionality that automatically performs a process or process steps unless the description explicitly describes user intervention or manual operation.

It should be understood that claims that include fewer limitations, broader claims, such as claims without requiring a certain feature or process step in the appended claim or in the specification, clarifications to the claim elements, different combinations, and alternative implementations based on the specification, or different uses, are also contemplated by the embodiments of the present invention.

It should be understood that combinations of described features or steps are contemplated even if they are not described directly together or not in the same context.

It is understood to those of ordinary skill in the art that a processor comprises additional circuitry that is implemented to support the operation of the processor in a device such as non-volatile memory.

It is to be understood that additional embodiments of the present invention described herein may be contemplated by one of ordinary skill in the art and that the scope of the present invention is not limited to the embodiments disclosed. While specific embodiments of the present invention have been illustrated and described, numerous modifications come to mind without significantly departing from the spirit of the invention, and the scope of protection is only limited by the scope of the accompanying claims.

1. A device for producing an output image using one or more image sensors, comprising:
a plurality of image sensors that each outputs a captured image if that image sensor is activated to capture a scene, and each image sensor has a different perspective view of the scene; and
a processor that is configured to
receive an input signal instructing the device to produce an output image,
perform sensor activation wherein, in response to receiving the input signal, the processor controls whether each image sensor is activated,
implement motion processing that determines whether there is motion in the scene and generates a motion output based on the determination, and
select output from which image sensor to use as a function of the motion output and sensor activation in producing the output image in accordance with at least two captured images.

2. The device of claim 1 wherein the processor is further configured to selectively apply power to one or more individual ones of the image sensors whereby the processor powers on or power off a corresponding image sensor.

3. The device of claim 1 wherein the processor is further configured to selectively apply power to one of the image sensors while the processor maintains a second one or all other ones of the image sensors to be power off.

4. The device of claim 1 wherein the processor is further configured to apply power to one or more individual ones of the image sensors before or approximately at the same time as the processor activates a corresponding image sensor to capture an image.

5. The device of claim 1 wherein the processor is further configured to perform activation to capture a scene only after the processor selectively applies power to one or more individual ones of the image sensors to power that correspond sensor on to be operable.

6. The device of claim 1 wherein the processor is further configured to implement a power saving mode for the device in which the processor is configured to remove power from being applied to a particular one of the image sensors in order to turn that image sensor off while the device continues to operate.

7. The device of claim 1 wherein the processor is configured to activate only one of the image sensors to capture a scene in response to receiving the input signal.

8. The device of claim 1 wherein the processor is configured to activate at least two o image sensors to operate simultaneously with respect to capturing a scene.

9. The device of claim 1 wherein the processor is configured to select output from only one of the image sensors to be the at least two captured images when the processor has powered off one or more other sensors.

10. The device of claim 9 wherein the processor is configured to power off the one or more other sensors as part of implementing a power savings mode for the device.

11. The device of claim 1 wherein the processor is configured to select output from only one of the image sensors to be the at least two captured images when the motion output indicates that motion has not been detected in the scene.

12. The device of claim 1 wherein the processor is configured to select output from a first one of the image sensors and a second one of the image sensors to be the at least two captured images.

13. The device of claim 12 wherein the processor is configured to select output the second one of the image sensors to be included in the at least two captured image when the processor determines from the motion output that motion has been detected in the scene.

14. The device of claim 1 wherein the processor is configured to produce the output image in accordance with the at least two captured images.

15. The device of claim 14 wherein the processor is configured to produce the output image in accordance with the at least two captured images, wherein the at least two captured images are only from one of the image sensors.

16. The device of claim 14 wherein the processor is configured to produce the output image in accordance with the at least two captured images, wherein the at least two captured images are plural captured images from one of the image sensors and plural captured images from another one of the image sensors.

20. The device of claim 1 wherein the processor is configured to determine whether there is motion in the scene by processing captured images from one of the image sensors and other one of the image sensors.

21. The device of claim 1 wherein the processor is configured to determine whether there is motion in the scene by processing captured images from only one of the image sensors.

22. The device of claim 1 wherein the processor is configured to display the output image on a display screen of the device in response to receiving the input signal.

23. The device of claim 1 wherein the processor is configured to select output from which sensor comprising the processor being configured to receive captured images which are output by the image sensors.

24. A computer-implemented method for producing an output image, comprising:
receiving an input signal instructing a device comprising a plurality of image sensors and a processor to produce an output image, wherein each image sensor outputs a captured image if that image sensor is activated to capture a scene, and each image sensor has a different perspective view of the scene;
performing sensor activation, wherein, in response to receiving the input signal, allowing the processor to control whether each image sensor is activated;
implementing motion processing that determines whether there is motion in the scene and generates a motion output based on the determination; and
selecting output from which image sensor to use, by the processor, as a function of the motion output and sensor activation in producing the output image in accordance with at least two captured images.

25. A non-transitory computer readable storage medium configured to store computer instructions that when executed causes a processor to:
receive an input signal instructing a device comprising a plurality of image sensors and the processor to produce an output image, wherein each image sensor outputs a captured image if that image sensor is activated to capture a scene, and each image sensor has a different perspective view of the scene;
perform sensor activation, wherein, in response to receiving the input signal, the processor controls whether each image sensor is activated;
implement motion processing that determines whether there is motion in the scene and generates a motion output based on the determination; and
select output from which image sensor to use as a function of the motion output and sensor activation in producing the output image in accordance with at least two captured images.
